(19) United States
(12) Patent Application Publication
(10) Pub. No.: US 2007/0176740 A1
(43) Pub. Date: Aug. 2, 2007

(54) Vehicle modular security system

(76) Inventors: Jean-Pierre Aubertin, Laval (CA); Martin Tessier, Mascouche (CA); Philippe Meilleur, Montreal (CA); Patrick Noel, Ste-Marthe-sur-le-Lac (CA)

Correspondence Address: ROBIC, CENTRE CDP CAPITAL, 1001, VICTORIA SQUARE - BLOC E - 8TH FLOOR, MONTREAL, QC, H2Z 2B7, CA

(21) Appl. No.: 11/637,058

(22) Filed: Dec. 12, 2006

Related U.S. Application Data
(60) Provisional application No. 60/749,061, filed on Dec. 12, 2005.

(51) Int. Cl. B60R 25/00

(52) U.S. Cl. 340/5.72; 340/5.64; 307/10.2; 340/426.11; 307/10.5

(57) ABSTRACT

Vehicle modular security system having an authentication device for generating authentication signals, an authenticating apparatus at a vehicle for receiving the authenticating signals from the authenticating device and generating validation signals, a master controller at the vehicle for receiving the validation signals from the authenticating apparatus and generating control signals, at least one slave controller module at the vehicle for receiving the control signals from the master controller and generating security restriction signals, and modified circuits at the vehicle for receiving the security restriction signals from the at least on slave controller and deteriorating a capacity of the vehicle to be used.

### FIELD OF THE INVENTION

The present invention relates to a vehicle security system.

### SUMMARY OF THE INVENTION

According to the present invention, there is provided a vehicle modular security system comprising:
an authentication mean for generating authentication signals;
an authenticating apparatus at a vehicle for receiving the authenticating signals from the authenticating mean and generating validation signals;
a master controller at the vehicle for receiving the validation signals from the authenticating apparatus and generating control signals;
at least one slave controller module at the vehicle for receiving the control signals from the master controller and generating security restriction signals; and
modified circuit means at the vehicle for receiving the security restriction signals from the at least on slave controller and deteriorating a capacity of the vehicle to be used.

Preferably, the vehicle modular security system includes a selectively operable activation/deactivation security module called “master” and one or more security modules operating as slave(s). The master module may be composed of any user authentication apparatus like an encrypted key (transponder) reader for user validation, for example. The slave module of the modular security system may be composed of a controller controlling any combination of signal modification in order to retain the vehicle from leaving and/or being used, and could be disposed anywhere in the vehicle for retaining the vehicle from starting and/or from moving and/or from being used, if applicable, by disconnecting the fuel pump or the drive selector, for example, and could be combined with other slave(s) module(s), or not, in order to enforce the security of the system, if desired. The method of communication between the master and the slave(s) may be by data transmission, encrypted or not, bidirectional or not, on any data communication bus of the vehicle, or using, but not limited to, any other data transmission method like data modulated over any signal or voltage of the vehicle including the power supply of the slave module(s), which can be, or not, the whole power supply of the vehicle.

The vehicle modular security system may also include sensors, alarm functions and other security features, like, but not limited to, horn and/or siren output and user and/or central signalling of a theft attempt, in the master module and/or in a slave module.

The vehicle modular security system may also include additional remote controlled features like, but not limited to, for operating the door locks or other similar features, and security bypass that could be needed, using a data bus of the vehicle or not, or any other data communication method.

Preferably, the system comprises alone or in combination:
a security module acting as the master of the system in order to control the system's status and validate the user by the use of a transponder;
a security module acting as the master of the system in order to control the system's status and validate the user upon receipt of a valid radio-frequency (RF) signal;
a security module acting as the master of the system in order to control the system's status and validate the user upon receipt of a valid infrared (IR) signal;
a security module acting as the master of the system in order to control the system's status and validate the user upon receipt of any signal or any combination of signals considered as acceptable for permitting to change the status of the system;
a security module acting as the master of the system that can manage remote communications of arming/disarming and/or sending alarm status to the user and/or to a security central;
a security module acting as the master of the system that can manage extended features like, but not limited to, activating the door lock commands, which command may be used to arm the system;
a security module acting as the master of the system in order to control the system's status that can rearm itself upon detection of conditions that are meant to;
a security module acting as slave that is composed of circuit opening terminals for opening circuits in the vehicle in order to retain it from starting/moving/being used;
a security module acting as slave that is composed of circuit closing terminals for closing circuits in the vehicle in order to retain it from starting/moving/being used;
a security module acting as slave that is composed of circuit/signal modifications/alteration terminals for modifying/altering signals/circuits in the vehicle in order to retain it from starting/moving/being used;
a security module acting as slave that is composed of any combinations of circuit/signal/modifications/alteration terminals for modifying/altering more than one type of circuits/signal at one time, or for, by example, being useable in different conditions/configurations in the vehicle in order to retain it from starting/moving/being used;
a security module acting as slave that is intended to be used for alarm features like, but not limited to, horn and/or siren activation in order to perform dissuasive actions upon theft attempt;
a security module acting as slave that is intended to be used for alarm features like, but not limited to, sending alarm status to a user and/or a central upon theft attempt;
a security module acting as slave that is based on the master's status for rearming;
a security module acting as slave that automatically rearms upon power loss;
a security module acting as slave that automatically rearms upon detection of conditions considered as vehicle non-use;
a security module acting as slave that automatically rearms upon detection of conditions that are meant to;
a modular security system that communicates by data, encrypted or not, between the master and the slave(s);
a modular security system that communicates on at least one data bus of the vehicle, which is original by the manufacturer or not, between the master and the slave(s);
a modular security system that communicates by data modulated over any signal or voltage of the vehicle, which wire/signal is original by the manufacturer or not, between the master and the slave(s), including multiplexing of a data signal on the power supply of the module(s), which supply can be the whole vehicle's supply or not;
a modular security system that communicates by radio frequency, infrared, fiber optic or any other data transmission method, between the master and the slave(s);
a modular security system that interacts with the vehicle in order to change its status and/or operate conjugated actions, using at least one data bus or not, for example.

### BRIEF DESCRIPTION OF THE DRAWING

FIG. 1 is a schematic bloc diagram for integration of a modular security system in a vehicle, according to a preferred embodiment of the present invention.

### DETAILED DESCRIPTION OF THE INVENTION

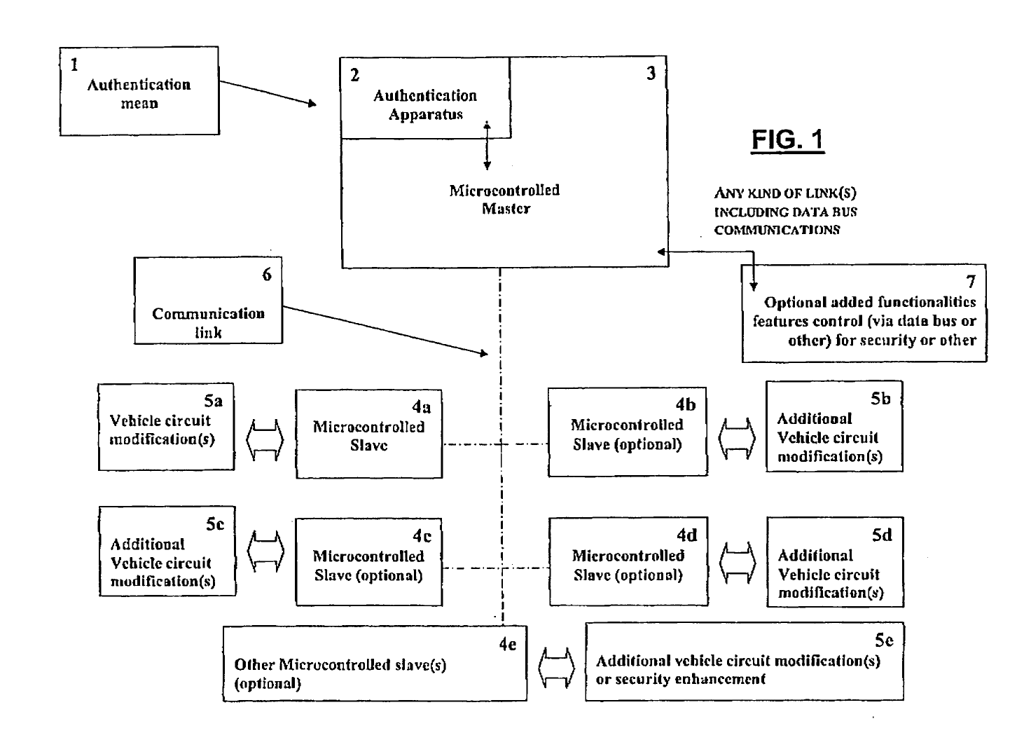

Referring to FIG. 1, there is shown a diagram for integration of a modular security system in a vehicle, according to a preferred embodiment of the present invention. The system includes an authentication mean 1 for generating authentication signals, an authenticating apparatus 2 at a vehicle for receiving the authenticating signals from the authenticating mean 1 and generating validation signals, a master controller 3 at the vehicle for receiving the validation signals from the authenticating apparatus 2 and generating control signals, at least one slave controller module 4a, 4b, 4c, 4d, 4e at the vehicle for receiving the control signals from the master controller and generating security restriction signals, and modified circuits 5a, 5b, 5c, 5d, 5e at the vehicle for receiving the security restriction signals from the at least on slave controller 4a, 4b, 4c, 4d, 4e and deteriorating a capacity of the vehicle to be used.

The authentication mean 1 may be a transponder, an accessories input sequence operated in the vehicle, a signal by radio-frequency modulation (RF), by infrared (IR) or by any other signal(s) that may be physically activated or not including activation by a computer, a home automation system, by internet or by any other network, or any condition(s) or combination(s) of signal(s) considered as acceptable.

The authentication apparatus 2 may be a receiver for receiving the authentication signals. It may be embodied as, but not limited to, a transponder reader, a RF receiver or even signal(s) inputs for detecting a valid logic input sequence of vehicle's accessories. The authentication apparatus 2 may be integrated in the master controller 3.

The controller 3 acts as master of the modular security system to supervise actions of the security system, which includes validation of the user using the mentioned authentications possibilities and disarming the slave modules upon a valid user authentication in order to permit the vehicle use. The controller 3 may supervise the arming of the slave(s) module(s) 4a, 4b, 4c, 4d, 4e . The controller 3 may supervise other features like, but not limited to, alarm reporting, alarm dissuasive effects like the activation of a horn and/or a siren; door lock functions or other additional desired features to be used with a security system, using any communication link(s) to the host vehicle including the data bus. The controllers program may be upgradeable or not, locally or remotely. The controller 3 may use an external card for its program and/or its features. The controller may be compatible with a plurality of subsystems and may recognize automatically in which car make/brand/model/year it is connected in order to perform correct actions.

The slave controller modules 4a, 4b, 4c, 4d, 4e are used to apply the security restrictions, such as but not limited to: opening vehicle circuit(s), closing vehicle circuit(s), modifying in any way a circuit and/or a signal and/or a vehicle computers state in order to deteriorate the vehicle's capacity to be used or any combination. The slave(s) module(s) 4a, 4b, 4c, 4d, 4e are preferably disposed away from the master controller 3 and/or hidden from the user or from an eventual thief in order to enhance the security level of the system. The slave controller modules 4a, 4b, 4c, 4d, 4e may include several circuit modification capabilities in order to perform combinations of restrictions with a unique slave, and/or in order to constitute a unique slave module permitting various configurations of circuit modifications. The slave modules 4a, 4b, 4c, 4d, 4e may also integrate or constitute a slave to perform alarm features like, but not limited to, horn and/or siren activation and/or alarm status sending, The slave(s) module(s) 4a, 4b, 4c, 4d, 4e may be self-learning upon predetermined conditions like, but not limited to, power loss. The slave controller's program may be upgradeable, locally or remotely, and may use an external card for its program and/or its features. The slave controller's program may be compatible with several of subsystems and may recognize automatically in which car make/brand/model/year it is connected in order to perform correct actions.

The vehicle(s) circuit modification(s) 5 are achieved in order to deteriorate the vehicle's capability of being used. The modification(s) 5 includes every modification of the normal state of working for the host vehicle. The modifications 5 may be one of the following, but not limited to: opening the supply circuit of a gas pump and/or the ignition circuit, altering a user authentication mechanism and/or a drive selection and/or speed controller apparatus used for moving the vehicle, or any other signal/circuitry modification or combination, or any modification in order to affect any vehicle's normal computer(s) state.

The communication link 6 or method between the master 3 and the slave(s) 4a, 4b, 4c, 4d, 4e may be a data communication, encrypted or not, bidirectional or not, on any data communication bus of the vehicle, or using any other data transmission method like, but not limited to: modulated data over any signal of the vehicle including the power supply of the slave module(s), which can be, or not, the whole power supply of the vehicle. The use of data modulation over the module's supply simplifies the installation and enhance the security aspect of the system, for example, by the absence of any suspect wire helping to locate an installed slave module. Similar advantages are to be expected if using the main vehicle's data bus since it is reachable at many different places.

Preferably, there is also provided an optional vehicle functionalities control 7 for security bypass or security enhancement, and/or door locks features or any similar features, using the data bus of the vehicle or not.

Although preferred embodiments of the present invention have been described in detail herein and illustrated in the accompanying drawing, it is to be understood that the invention is not limited to these precise embodiments and that various changes and modifications may be effected therein without departing from the scope or spirit of the present invention.

1. A vehicle modular security system comprising:
an authentication mean for generating authentication signals;
an authenticating apparatus at a vehicle for receiving the authenticating signals from the authenticating mean and generating validation signals;
a master controller at the vehicle for receiving the validation signals from the authenticating apparatus and generating control signals;
at least one slave controller module at the vehicle for receiving the control signals from the master controller and generating security restriction signals; and
modified circuit means at the vehicle for receiving the security restriction signals from the at least on slave controller and deteriorating a capacity of the vehicle to be used.

2. The system according to claim 1, wherein the authenticating apparatus is integrated in the master controller.

3. The system according to claim 1, wherein the master controller is connected to the at least one slave controller via a communication data bus link.

4. The system according to claim 1, wherein the master controller is connected to a security bypass system via a communication data bus link.
